(19) United States
(12) Patent Application Publication
(10) Pub. No.: US 2018/0339623 A1
(43) Pub. Date: Nov. 29, 2018

(54) PHORONOMIC BACKREST FOR A CHAIR OR SEAT

(71) Applicant: iii solutions GmbH, Baar (CH)

(72) Inventor: Andreas REINHARD, Baar (CH)

(73) Assignee: iii solutions GmbH, Baar (CH)

(21) Appl. No.: 15/771,772

(22) PCT Filed: Oct. 12, 2016
(86) PCT No.: PCT/CH2016/000133

§ 371 Date: Apr. 27, 2018

(30) Foreign Application Priority Data
Oct. 28, 2015 (CH) 1575/15

(51) Int. Cl. B60N 2/809; A47C 7/40

(52) U.S. Cl. CPC B60N 2/809; A47C 7/40

(57) ABSTRACT

The backrest brings about the stimulation of underlying movements in the back muscles. The backrest consists of at least one moveable element (1) formed of two flexible column strips (2, 3) running over one another and connected via struts (4), and which track the spinal column of the person using the chair with a gap. This element (1) extends upwards from the centre of the rear end of the seating surface. The front column strip carries a number of moveable elements (6) laterally protruding on both sides like ribs (6) from the central moveable element (1), each having two transverse strips (7, 8) for supporting the back region of the seated person exclusively on both sides of their spinal column. Each time the backrest constructed in this way is leant upon, a movement of its contact surface is brought about in different directions, and thereby a massaging of the back muscles of the user.

The present invention relates a backrest, which is to be attached to a chair or seat, and which offers a significantly improved sitting comfort, in particular for continuing sitting periods, in that it triggers subtle movements in the back muscles of the sitting person by means of functional and application-defined phoronomic elements. It adapts perfectly to the back of the sitting person and subtle support movements in the back area are triggered by the movements of the person, which also impacts the remaining body parts. The phoronomy means: movement of an object is the change of the external conditions of said object to a given space, according to Immanuel Kant. The movement of the space, in contrast to the movement of a body, is purely phoronomical, i.e. in itself, it has no moving force.

In view of the fact that for the human being, in particular for the working person, sitting is a relatively modern phenomenon and on principle only became widespread with the emergence of the service society and with the introduction of the computers, the sitting as body posture gained increased importance and has a corresponding effect on the public health due to the very large number of people, who nowadays spend their workdays sitting. In Germany, there are a total of 4 billion chairs for the approx. 80 million inhabitants, which means that there are approx. 50 chairs for one inhabitant. The chair as product thus proves to be an important object, with which every person is familiar, and simply because of its extremely extraordinarily extensive use, it should provide a maximum of comfort and should support the well-being and the physical health.

The prior art captures a variety of office chair designs comprising a large variety of backrest designs, all of which strive to meet the desired goals, namely to provide for a variable adjustment of the chair elements for adaptation to a large variety of bodies, a healthy body posture, a good circulation of the buttocks and a fatigue-free sitting. The typical office chair has a chassis comprising a plurality of legs or a horizontal ring, to which freely guided rollers are mounted, so that the chair can on principle be rolled in all directions. The typical office chair further has a stable sitting surface and an inherently mostly stiff backrest. The sitting surface can be rotated about a vertical axis on the chassis and can be height-adjusted, but is inherently stationary, as is the backrest. The height and the angle of inclination thereof can be adjusted and can mostly also be pivoted backwards in a spring-supported manner. However, sitting on such a chair feels like a sack of potatoes, which stands on the floor and is supported against a wall. The buttocks and the back are hardly moved, which is harmful for the circulation and the well-being.

A more ergonomic office chair model is disclosed for example in DE 10 2005 033052. It shows a seating furniture, the sitting surface of which is located on a tilting device. A locking device in the form of an annular tube air cushion is assigned to this tilting device in such a way that the tilting angles of the tilting movements can be adjusted via the air cushion. A possible embodiment relates to a plurality of air cushions, which can be inflated individually, for the purpose of a targeted deactivation of the tilting movements.

The same is known from a sitting device from US 2008 0079301. A device for increasing the perception of body movements as well as of health is shown. In its core, the methodology of this system is identical with that from [0004].

An interesting design is shown in DE 20 2008 006 781 U1, in that one or a plurality of Finray elements are installed therein, which extend in the longitudinal direction of the backrest. Finray elements consist of two strap-like strips of flexible material, which are arranged on top of one another, wherein the ends of the strips are fixedly connected to one another or are in each case stationarily fastened to a support element. These two strips are connected to one another via webs, which are fastened to the insides of the strips in a pivotable or flexible manner, wherein these webs can be fastened on the strips orthogonally or obliquely thereto.

Based on this prior art, it is the object of the present invention to further develop a backrest for a chair or seat in such a way that it triggers subtle movements of the sitting person leaning against it, without this person necessarily directly perceiving these movements. On the chair, the movements are to be responded to by the same induced movements. This backrest brings the sitting to a new level and is to lead away from the inactive sitting towards a dynamic, stimulating sitting, which stimulates the circulation of the back. The back is to be protected better and is to be moved at the same time. Its movements also impact the buttocks and the thighs.

This object is solved by backrest for a chair or seat to stimulate subtle movements in the back muscles, which is characterized in that the backrest consists of a central phoronomic element of two column straps, which extend upwards from the center of the rear end of the sitting surface, and of a number of phoronomic elements, which protrude laterally like ribs on both sides from the central phoronomic element, in each case of two transverse straps to support the back muscles of the sitting person by means of the front transverse straps on both sides of the person's spine.

The figures show a chair or seat comprising such a backrest of phoronomic elements and its design and its function will be described and explained in the description below.

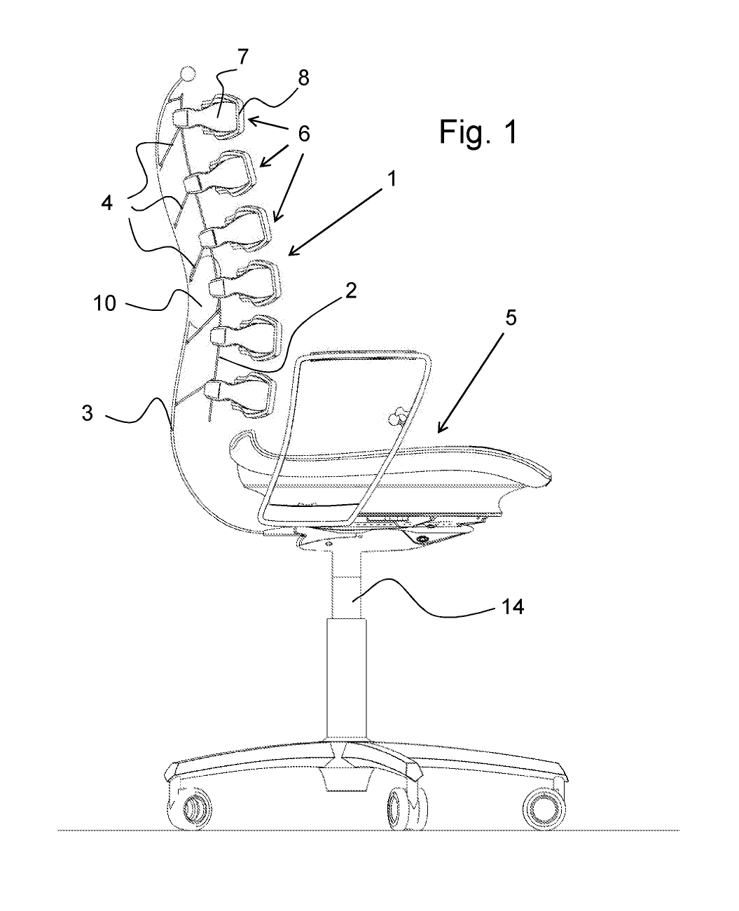

FIG. 1: shows the chair in a side view, comprising the backrest of a central phoronomic element, such as the laterally branching phoronomic elements;

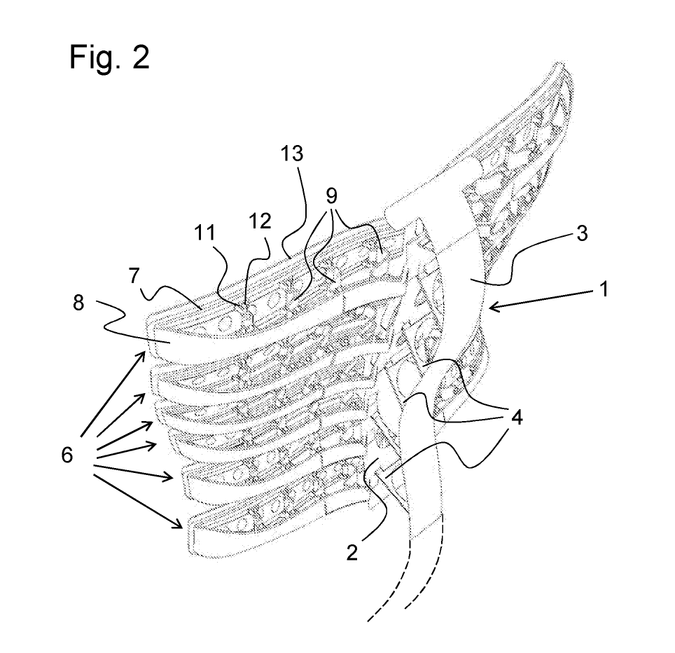

FIG. 2: shows a perspective view of the backrest of the chair of phoronomic elements, viewed at an angle from above onto the rear side;

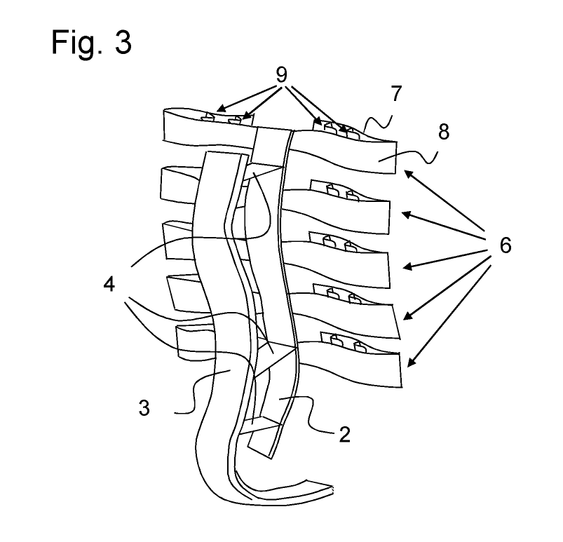

FIG. 3: shows a perspective view of a simple, yet highly effective backrest of phoronomic elements, viewed at an angle from above onto the rear side;

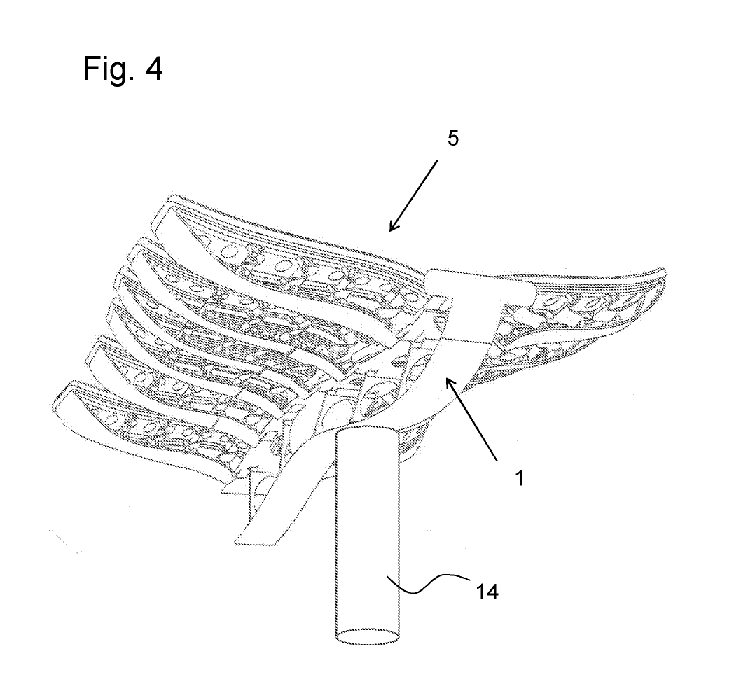

FIG. 4: shows an illustration of the sitting surface of a chair or seat comprising phoronomic elements.

An office chair for stimulating subtle movements of the back muscles is illustrated in FIG. 1 in a view from the side. The chassis, the support 14 and the sitting surface 5 are constructed in a conventional manner here, and the extraordinary aspect of the chair is its backrest and its design of phoronomic elements for the induction of subtle movements. For this purpose, such a phoronomic element 1 extends vertically upwards, along the spine of a person sitting on the sitting surface 5 of the chair as backrest behind the sitting surface 5, but always at a distance to the spine. The phoronomic element 1 consists of two column straps 2, 3, wherein each of these straps is a flat, elastically deformable strap, for example made of plastic, of wood or a metal sheet. The rear column strap 3 is fastened below the sitting surface 5 and initially runs backwards from here and then upwards with a lateral contour, which resembles the contour of the buttocks and of the back of a sitting person. However, it can be set up in its inclination on its fastening point below the sitting surface.

These two column straps 2, 3 are connected to one another at several locations by means of connecting webs 4. Here, these connecting webs 4 are stiff flat elements, which are connected to the inside of the column straps 2, 3 in an articulated manner on both ends, but which, as can be seen, are arranged so as to run oblique-angled to them. If pressure acts on the front column strap 2 from the sitting surface side, the distance to the rear column strap 3 is reduced and the front column strap 2 simultaneously moves slightly upwards relative to the rear column strap 3 due to the geometry of the arrangement of the connecting struts 4. Every time user of the chair thus leans against the backrest, the bearing surface for his back thus moves slightly upwards and thus massages his back muscles. An air cushion 10, which acts as progressive compression spring, is installed between two struts 4 here. When relieving the backrest, the latter is thus returned back into its initial state again. An air tube can lead from the air cushion 10 to a connecting point, which is equipped with a valve, so that said air cushion can be inflated by means of a pump with an individually selectable pressure and air can be released via the valve to individually shape the column straps 2, 3. It goes without saying that a plurality of such separate air cushions can also be installed between the connecting webs 4. By varying the length of the connecting webs, the arrangement and the number thereof and the filling pressure of the individual air cushions, the contour of the front column strap 2 can be adapted to a certain back contour of a user. In the alternative, at least one or also a plurality of steel compression springs can be installed between the front column strap 2 and the rear column strap 3.

At the column strap 2, which is in front here, a plurality of transverse straps 6 branch off transversely thereto like ribs from the central phoronomic element 1 towards both sides. These transverse straps 6 are also phoronomic elements 6 and in each case consist of a front transverse strap 7 and a rear transverse strap 8. These two transverse straps 7, 8 taper off on their outer end into a common tip and are connected to one another at that location or they each form a one-piece part, respectively. On the opposite, inside, they are fastened to the front column strap 2 of the central phoronomic element 1.

The special design of this backrest follows from FIG. 2, which discloses a specific embodiment alternative in detail. The backrest is thereby illustrated in a perspective view, seen at an angle from above onto the rear side. The central phoronomic element 1 can be seen, consisting of the front column strap 2 and the rear column strap 3, but which continues on, as is shown below by means of a dotted line, as can be seen in FIG. 1. These two column straps 2 and 3 are connected to one another by means of connecting webs 4. These connecting webs 4 are formed here by flat, stiff elements, each of which are provided with a central hole to save weight. On both ends, these connecting webs 4 are connected to the inside of the front column strap 2 or of the rear column strap 3, respectively, in an articulated manner. It thus immediately becomes clear that a pressure from the front onto the front column strap 2 reduces the distance to the rear column strap 3, and the front column strap 2 moves slightly upwards due to the geometry of the arrangement of the connecting webs 4, thus displace upwards relative to the rear column strap 3, which is fixedly mounted to the chair. The phoronomic elements 6, which branch off transversely to the side like ribs, are attached to the front column strap 2. They form the actual bearing surface of the backrest. When the front column strap 2 moves upwards and downwards relative to the rear column strap 3, as do the transversely protruding ribs, so that that the entire bearing surface for the back of the person sitting on the chair is moved slightly up and down, and in particular every time the person leans against the backrest again, it escapes slightly upwards. The extent of this upwards movement is a function of the bearing pressure and the dimensioning and geometric arrangement of the connecting webs 4 between the front column strap 2 and the rear column strap 3. The ribs are meanwhile also embodied as phoronomic elements 6. They are each formed by a front transverse strap 7 and a rear transverse strap 8. These two transverse straps 7, 8 are connected to a plurality of connecting webs 9. In the shown example, they consist of elastically flexible connecting webs 9, which each form an S and which are fastened to the insides of the transverse straps 7, 8 with both ends in an articulated manner. In the case at hand, this is realized in such a way that, on their ends, these connecting webs 9 have bolts 32, which protrude transversely, and which can be clicked into corresponding bolt sockets 11. These sockets 11 form two approximately semi-circular bolt sockets and they can be spread away from one another elastically, so that the bolts 12 of the connecting webs 9 can be clicked into these sockets 11 and can subsequently be pivoted back and forth in the sockets 11. The connecting webs 9 can thus be replaced easily by others. The removal and insertion can occur without any tools and quickly.

The joint connections of the connecting webs 4, 9 can be embodied so as to be displaceable in strap direction on at least one or also on both fastening sides of the webs with respect to the column strap 2, 3 or transverse strap 7, 8. For example, the bolt sockets 11 can be guided on the insides of the transverse straps 7, 8 in a longitudinally displaceable manner. This displacement can be adjusted by means of Bowden cables, wherein wire rope hoists are guided about a deflection roller in the end areas of the transverse straps 7, 8 and entrain the bolt sockets 11. The Bowden cables are guided via deflection rollers in the interior of the backrest design to an adjusting wheel well in sitting position, which can be brought into different rotational positions and which can be locked in every position.

The front transverse straps 7 are provided with holes here to save weight and their front sides are equipped with soft-elastic pads 13. When pressure acts onto the front transverse straps 7 from the front, the connecting webs 9, which are S-shaped here, are slightly deformed elastically and a slight relative displacement of the front transverse straps to the rear transverse straps 8 also results due to the geometry and their arrangement, wherein, depending on the direction of action of the resulting force, the rear transverse straps 8 either extend slightly further or are further curved for this purpose and the front transverse straps 7 curve forwards or backwards with their ends. As a whole, the front transverse straps 7 conform to the contour of the back of the user of the chair, who leans back. Due to the relative movement of the front transverse straps 7, which is induced by means of the contact pressure, in the direction to the outside or inside, the back muscles are also massaged in this direction, albeit only very subtly. With every new leaning against this backrest, the latter thus displaces slightly upwards and the transverse straps 7, which protrude transversely, are displaced slightly to the outside or inside, as the case may be. As a whole, a low-threshold, in fact a subtle, barely perceivable, but nonetheless highly effective massage of the back muscles is attained, which has a positive impact on the remaining body parts.

FIG. 3 shows a particularly advantageous embodiment, which also has a simple design. The rear column strap 3 is embodied to be stronger and stiffer and is connected to the front column strap 2, which is embodied to be weaker and more flexible, via at least three struts 4, which are installed in an articulated manner. The phoronomic elements 7, which branch off and which, in turn, in each case consist of a front transverse strap 7 and a rear transverse strap 8, are attached on this front column strap. A plurality of S-shaped connecting webs 9 are installed between them. This backrest design turns out to be highly dynamical and extremely comfortable for the user of the chair, who leans back. When leaning back, all of the elements interact harmoniously and conform to the back muscles by effecting subtle movements, wherein the area directly behind the spine of the user remains free.

The use of phoronomic elements in the same or in a very similar way as for the backrest is optionally also conceivable for the sitting surface 5. For this purpose, FIG. 4 illustrates a view of such a sitting surface, viewed from the bottom front and at an angle to the top, with the suggested support 14, wherein the chassis is not illustrated on the bottom. In this case, slight weight transfers of the person sitting on this sitting surface 5 effect subtle dynamic reactions of the sitting surface 5, in that it is displaced and is slightly distorted, so that a subtle movement is induced, which is beneficial for the blood circulation in the buttocks area and in the thighs. The thighs are thereby located in concave shells, which are formed by the upper transverse straps here, on which the thighs come to rest, while the central phoronomic element 1 runs between the legs along the latter and forms a dent, which is bent downwards, for the buttocks. These contours can be adapted individually to the profile of a person by adapting the connecting webs and the spring cushion between the straps.

Your backrest designed in such a way can be used on a large variety of chairs or seats. A broad field of application are office, work and leisure chairs, for instance those, which are used to watch television. However, such a backrest can on principle also be installed on seats for mobile applications in vehicles, such as private cars, trucks, delivery vans, busses, taxis, but also in ships, trains and airplanes and on any other chairs or seats, for example on the seats or chairs in convention halls or movie theaters and theaters. Wherever it is used, it significantly increases the sitting comfort and the well-bring, in particular in those cases, in which long sitting periods are necessary or desired.

### LIST OF REFERENCE NUMERALS

1 phoronomic element for backrest

2 front column strap on 1

3 rear column strap on 1

4 webs on 1

5 sitting surface

6 transverse ribs

7 front strap of the transverse strap

8 rear strap of the transverse strap

9 webs on 6

10 air cushion

11 bolt socket

12 bolt

13 flexible padding

14 support

1-15 (canceled)

16. A backrest for a chair or seat to stimulate subtle movements in the back muscles, wherein the backrest comprises a central phoronomic element (1) of two column straps (2, 3), which are intended to extend upwards from the center of the rear end of the sitting surface (5), and which can be fastened to the chair or seat for this purpose, and of a number of phoronomic elements (6), which protrude laterally like ribs on both sides from the central phoronomic element (1), in each case of two transverse straps (7, 8) to support the back muscles of the sitting person by means of the front transverse straps (7) on both sides of the person's spine,
wherein the backrest comprises a central phoronomic element (1), which extends upwards from the center of the rear end of the sitting surface (5), wherein it is embodied so as to be capable of being tilted backwards with adjustable resistance, and wherein its front column strap (2) can be bent so as to follow the course of a spine, the connecting webs (4) are embodied so as to be longitudinally changeable to the rear column strap (3), or to be adjustable in an articulated manner or that their articulation on the opposite insides of the column straps (2, 3) on the column straps (2, 3) are embodied in a longitudinally displaceable manner, so that they define the distance of the column straps (2, 3) in relaxed position and said front column strap (2) changes in shape and length in accordance with the arrangement and embodiment of the connecting webs (4) in response to local pressure thereon, and wherein, starting at the front column strap (2) on both sides, a plurality of transverse strips (7), are integrally molded like ribs (6) on both sides of the spine of the sitting person to support the back sections, are in each case connected via webs (9) to rear transverse strips (8), which, in turn, are integrally molded on the front (2) or rear column strap (3), and wherein these connecting webs (9) are also embodied so as to be longitudinally changeable or adjustable in an articulated manner or that their articulations to the transverse strips (7, 8) thereon are embodied in a longitudinally displaceable manner, so that these webs (9) define the distance of the transverse strips (7, 8) in relaxed position and the front transverse straps (7) change in shape and length in accordance with the arrangement and embodiment of the connecting webs (9) in response to local pressure thereon.

17. The backrest according to claim 16, wherein the connecting webs (4) between the front and the rear column strap (3) are stiff flat struts (4), which are articulated on the column straps in an oblique-angled manner between the front column strap (2) and the rear column strap (3) in an articulated manner on both ends across the width thereof, so that a displacement of the front column strap (4) against the rear column strap (3) effects a relative displacement thereof against one another in strap direction as well as deformation, and that the webs (9) between the transverse straps (7, 8) form elastically flexible webs, which are curved once or several times, wherein these webs are fastened in an articulated manner on both ends on the inside of the opposite insides of the transverse straps (2, 3).

18. The backrest according to claim 16, wherein the joint connection of the connecting webs (4, 9) is embodied in a displaceable manner in strap direction at least on one fastening side of the webs with respect to the column strap (2, 3) or transverse strap (7, 8), wherein the displacement can be adjusted by means of Bowden cables.

19. The backrest according to claim 17, wherein the joint connections of the connecting webs (4, 9) with the column straps (2, 3) or the transverse straps (7, 8) are embodied as click connections, in each case comprising an elastically spreadable bolt socket (11), into which a bolt (12) can be clicked transversely to its direction of travel by spreading the bolt socket (11), so that the connecting webs (4, 9) can be replaced without any tools.

20. The backrest according to claim 17, wherein the joint connections of the connecting webs (4, 9) with the column straps (2, 3) or the transverse straps (7, 8) are embodied as click connections, each comprising an elastically spreadable bolt socket (11), into which a bolt (12) can be clicked transversely to its direction of travel by spreading the bolt socket (11), so that the connecting webs (4, 9) can be replaced without any tools, wherein the bolt sockets (11) are arranged on the insides of the column straps (2, 3) or the transverse straps (7, 8) so as to be capable of being displaced in the strap direction thereof, and can be secured in every displacement position.

21. The backrest according to claim 16, wherein below the sitting surface (5), the rear column strap (3) is connected to the chair with its lower end, which is curved towards the sitting surface (5), below it, and starting at the connecting point viewed from the side of the chair, forms a curve, which conforms to the contour of the outer shape of buttocks and back of a sitting person, viewed from the side, and wherein the front column strap (2) is held only via the connecting webs (4) to the rear column strap (3).

22. The backrest according to claim 20, wherein an air cushion is installed as progressively acting compression spring between at least two connecting webs (4) between the front columns strap (2) and the rear column strap (3), wherein the air cushion leads with an air tube to a connecting point, which is equipped with a valve, so that said air cushion can be inflated by means of a pump with an individually selectable pressure and air can be released via the valve to individually shape the column straps (2, 3).

23. The backrest according to claim 20, wherein at least one steel compression spring is installed between the front column strap (2) and the rear column strap (3).

24. The backrest according to claim 16, wherein on their side, which faces the sitting surface (5), the front transverse straps (7) are equipped with a pad (13) each of soft-elastic material.

25. The backrest according to claim 16, wherein some or all of the struts (4, 9, 13, 17) are articulated to the insides of the strips on one side or on both sides in an articulated manner, i.e. in a hinged manner, and the hinge axis of the articulated articulations on the inside of the strips (2, 3; 7, 8; 11, 12; 15, 16) are arranged so as to be capable of being displaced in the longitudinal direction thereof and can be locked in each displacement position.

26. The backrest according to claim 25, wherein the hinge axes of the articulated articulations on the inside of the straps (2, 3; 7, 8) are arranged so as to be capable of being displaced in the longitudinal direction thereof, a Bowden cable is connected thereto, which, in the end area of the straps (2, 3; 7, 8), leads around a deflection roller arranged at that location and via further deflection rollers to a lockable lever, adjusting wheel or rotary handle, so that they can be locked in every displacement position.

27. The backrest according to claim 16, wherein some or all of the struts (4, 9) are embodied as gas pressure springs, which are articulated with their ends on the insides of the strips (2, 3; 7, 8), which connect them.

28. The backrest according to claim 16, wherein the spaces between the strips (2, 3; 7, 8) and their struts (4, 9) are filled by a soft-elastic material, which acts as compression spring.

29. The backrest according to claim 16, embodied as sitting surface, wherein the column straps run in the middle along the sitting surface and the transverse straps run concavely, seen from above, for accommodating the thighs of a person sitting thereon, and wherein the sitting surface, which is formed by the upper transverse straps, and the backrest, which is formed by the front transverse straps of the backrest, are in each case covered with a cover cushion, which is divided into a plurality of compartments, which are each filled with a gel.
